(19) United States
(12) Patent Application Publication
(10) Pub. No.: US 2002/0067929 A1
(43) Pub. Date: Jun. 6, 2002

(54) High voltage developer bias multiplexer

(76) Inventors: Maurice H. James, Rochester, NY (US); John W. Prebola, Sodus, NY (US); Julian J. Galban, Rochester, NY (US)

Correspondence Address: John E. Beck, Xerox Corporation, Xerox Square 20A, Rochester, NY, 14644, US

(21) Appl. No.: 09/729,625

(22) Filed: Dec. 1, 2000

(51) Int. Cl. G03G 15/00; H02J 1/00

(52) U.S. Cl. 399/88; 307/38

(57) ABSTRACT

A high voltage multiplexer, useful in power supplies for electrophotographic printers, that converts a high voltage DC input into an AC modulated DC signal that is selectively applied to one of a plurality of outputs. The selected output depends on signals applied to a set of control inputs. That multiplexer is useful in a power supply system having a high voltage DC source for producing the DC input and a clock input for setting the AC modulation frequency. That power supply is useful in an electrophotographic printer having a plurality of developers and a controller. The power supply system then selectively powers one of the developers as directed by signals from the controller.

### FIELD OF THE INVENTION

This invention relates to high voltage multiplexing. More specifically it relates multiplexing high voltage DC and AC power for electrophotographic developers.

### BACKGROUND OF THE INVENTION

Electrophotographic marking is a well-known and commonly used method of copying or printing documents. Electrophotographic marking is performed by exposing a light image representation of a desired document onto a substantially uniformly charged photoreceptor. In response to that light image the photoreceptor discharges so as to create an electrostatic latent image of the desired document on the photoreceptor's surface. Toner particles are then deposited onto that latent image to form a toner image. That toner image is then transferred from the photoreceptor onto a substrate such as a sheet of paper. The transferred toner image is then fused to the substrate, usually using heat and/or pressure. The surface of the photoreceptor is then cleaned of residual developing material and recharged in preparation for the production of another image.

The foregoing broadly describes a black and white electrophotographic printing machine. Electrophotographic marking can also produce color images by repeating the above process once for each color of toner that is used to make the composite color image. For example, in one color process, referred to herein as the REaD IOI process (Recharge, Expose, and Develop, Image On Image), a charged photoreceptive surface is exposed to a light image which represents a first color, say black. The resulting electrostatic latent image is then developed with black toner particles to produce a black toner image. A recharge, expose, and develop process is repeated for a second color, say yellow, then for a third color, say magenta, and finally for fourth color, say cyan. The various color toner particles are placed in superimposed registration so that a desired composite color image results. That composite color image is then transferred and fused onto a substrate.

In electrophotographic printing the step of conveying toner onto a latent image is called development. In development, charged toner particles are applied to a latent image such that the toner particles adhere to the desired areas of the latent image.

There are several types of developers, including magnetic brush, scavengeless developers, and hybrid scavengeless developers. In hybrid scavengeless development toner particles are deposited from a toner loaded transport roll onto a donor roll that is disposed between the transport roll and the photoreceptor. The donor roll is electrically biased such that toner particles are attracted from the transport roll. Using an AC bias the toner on the donor roll can be moved into a toner powder cloud that forms in the gap between the donor roll and the photoreceptor. The latent image can then attract toner particles from the toner powder cloud, thereby developing the latent image.

Hybrid scavengeless development is highly advantageous because the donor roll acts as an electrostatic “intermediate” between the photoreceptor and the developer roll. This tends to reduce unwanted interactions between the developer and the photoreceptor. In color systems such as REaD, multiple developers are used. In such cases the developer power supply can simultaneously power all of the developers or only the developer that is actually depositing toner. Since hybrid scavengeless developers require a high DC voltage (say −500) and a high AC voltage (say 1500 V pk-pk), and since four developers in parallel presents a relatively high capacitive load (say 1200 pF), either a larger power supply must be used, or the high voltages must be selectively switched. Since large power supplies tend to be expensive, large, and heat producing it is beneficial to selectively switch the power supply voltages onto the developers as required. However, given the high voltages that must be switched this is not simple to do. While reed switches could be used the contacts would tend to burn out relatively quickly. Therefore, a new apparatus for selectively switching voltages from a developer power supply onto a developer would be beneficial.

### SUMMARY OF THE INVENTION

The principles of the present invention provide for selectively multiplexing high voltage DC and AC power. A high voltage multiplexer according to the principles of the present invention receives a high voltage DC signal and a set of control inputs. The high voltage DC signal is converted into an AC modulated DC signal that is selectively applied to one of a plurality of output, with the selected output depending on signals applied to the set of control inputs.

A power supply system according to the principles of the present invention includes a high voltage DC input, a clock input, a clock input, a set of control inputs, and a plurality of output lines. The high voltage DC input is converted into an AC modulated DC power signal that is selectively applied to one of the outputs lines, with the AC frequency being controlled by the clock input, and with the selected output line controlled by signals applied to the set of control inputs.

An electrophotographic printer according to the principles of the present invention includes a plurality of developers, a controller, and a power supply system that selectively powers the developers as directed by signals from the controller. The power supply system includes a high voltage DC power supply, a clock oscillator, a set of control inputs for receiving control signals from the controller, and a plurality of output lines connected to the developers. The high voltages DC input is converted into an AC modulated DC power signal that is selectively applied to one of the developers, with the AC frequency being controlled by the clock input, and with the selected developers controlled by signals applied to the set of control inputs.

### BRIEF DESCRIPTION OF THE DRAWINGS

Other aspects of the present invention will become apparent as the following description proceeds and upon reference to:

FIG. 1, which schematically illustrates an electrophotographic printing machine that incorporates the principles of the present invention;

FIG. 2, which illustrates a block diagram of a power supply system that selectively supplies a high DC voltage and a high AC voltage to a plurality of hybrid scavengeless developers that are used in the printing machine illustrated in FIG. 1;

FIG. 3, which illustrates part of a solid-state, high voltage multiplexer used in the power supply system illustrated in FIG. 2; and

FIG. 4, which illustrates the remainder of the solid-state, high voltage multiplexer used in the power supply system illustrated in FIG. 2.

### DETAILED DESCRIPTION OF A PREFERRED EMBODIMENT OF THE INVENTION

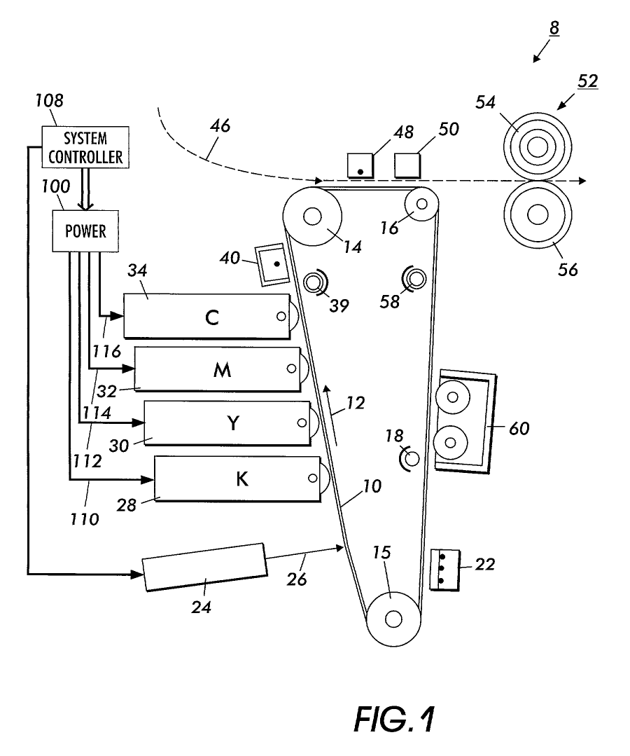

Referring now FIG. 1, the preferred embodiment of the present invention is an electrophotographic, multipass Recharge-Expose-and-Develop (REaD) Image-on-Image (IOI) printing machine 8 that uses hybrid scavengeless developers having selectively multiplexed biases.

The printing machine 8 includes an Active Matrix (AMAT) photoreceptor belt 10 which travels in the direction indicated by the arrow 12. Belt travel is brought about by mounting the photoreceptor belt about a drive roller 14 (that is driven by a motor which is not shown) and tension roller 15 and 16.

As the photoreceptor belt travels each part of it passes through each of the subsequently described process stations. For convenience, a single section of the photoreceptor belt, referred to as the image area, is identified. The image area is that part of the photoreceptor belt which is to receive the various toner layers which, after being transferred and fused to a substrate, produce the final color image. While the photoreceptor belt may have numerous image areas, since each image area is processed in the same way a description of the processing of one image area suffices to fully explain the operation of the printing machine.

The production of a color document takes place in 4 cycles. The first cycle begins with the image area passing a “precharge” erase lamp l 8 that illuminates the image area so as to cause any residual charge which might exist on the image area to be discharged. Such erase lamps are common in high quality systems and their use for initial erasure is well known.

The image area, processing stations, belt travel, and cycles define two relative directions, upstream and downstream. A given processing station is upstream of a second processing station if, in a given cycle, the imaging area passes the given processing station after it passes the second processing station. Conversely, a given processing station is downstream of a second if, in a given cycle, the imaging area passes the given processing station before it passes the second processing station.

As the photoreceptor belt continues its travel the image area passes through a charging station comprised of an AC scorotron 22. To charge the image area in preparation for exposure to create a latent image for black toner the AC scorotron charges the image area to a substantially uniform potential of, for example, about −500 volts. It should be understood that the actual charge placed on the photoreceptor for the black toner (and the other toner layers that are subsequently described) will depend upon many variables, such as toner mass and the settings of a subsequent development station (see below).

After passing the charging station the image area advances until it reaches an exposure station 24. At the exposure station the charged image area is exposed to a modulated laser beam 26 that raster scans the image area such that an electrostatic latent representation of a black image is produced. For example, illuminated sections of the image area might be discharged by the laser beam 26 to about −50 volts. Thus after exposure the image area has a voltage profile comprised of relatively high voltage areas of about −500 volts and of relatively low voltage areas of about −50 volts.

After passing the exposure station 24 the exposed image area passes a black development station 28 which deposits negatively charged black toner particles onto the image area. The charged black toner adheres to the illuminated areas of the image area thereby causing the voltage of the illuminated parts of the image area to be about −200 volts. The non-illuminated parts of the image area remain at −500 volts.

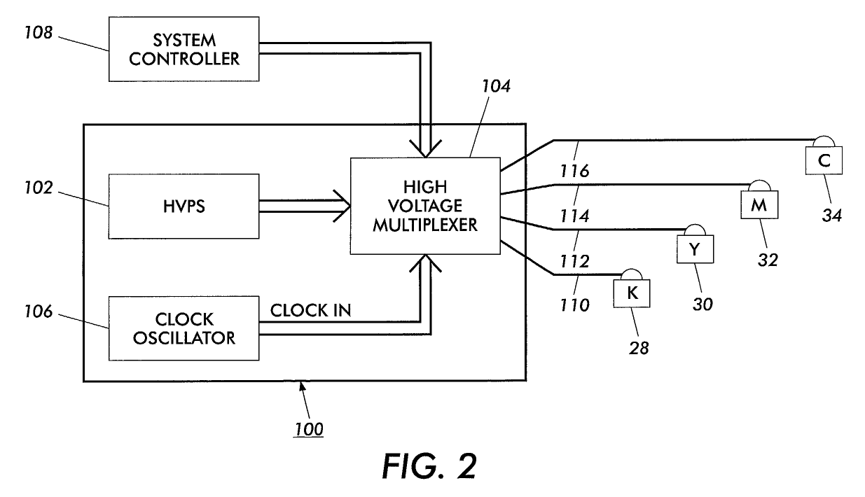

The black development station 28 is a hybrid scavengeless developer powered by a 1500 V peak-to-peak AC squarewave that is superimposed on −500 volts DC. The principles of the present invention relate to selectively powering the development stations (and the other development stations mentioned below). Selectively powering the development station is performed using a high voltage power supply system 100 shown in FIG. 2. That power supply system is discussed in more detail subsequently.

After passing the black development station the image area advances past a number of other stations, whose purposes are described subsequently, and returns to the precharge erase lamp 18. The second cycle then begins.

If either AC re-charging or split re-charging were directly used to recharge the image areas in the second cycle, significant amounts of black toner particles might be pulled off of the photoreceptor and deposited into the yellow developer, thereby causing Black in Yellow contamination. However, it has been found that a successful AC only recharge can be performed if the photoreceptor is first exposed so as to reduce the charges on the image area prior to recharging. In the electrophotographic printing machine 8 this is performed using the precharge erase lamp 18 to expose the image area. Therefore, as the image area advances past the precharge erase lamp 18, that lamp illuminates the image area.

After passing the precharge erase lamp the AC scorotron 22 recharges the image area to the charge level desired for exposure and development of the yellow image. Beneficially the AC scorotron has a high slope: a small voltage variation on the image area results in large charging currents. The voltage applied to the metallic grid of the AC scorotron 22 can be used to control the voltage at which charging currents are supplied to the image area.

The recharged image area with its black toner layer then advances to the exposure station 24. The exposure station exposes D the image area with the beam 26 so as to produce an electrostatic latent representation of a yellow image. As an example of the charges on the image area, the non-illuminated parts of the image area might have a potential about −450 while the illuminated areas are discharged to about −50 volts.

After passing the exposure station 24 the now exposed image area advances past a yellow development station 30 that deposits yellow toner onto the image area. Like the black development station, the yellow development station is a hybrid scavengeless developer powered by a 1500 V peak-to-peak AC squarewave superimposed on −500 volts DC. Furthermore, the yellow development station is selectively powered using the high voltage power supply system 100 shown in FIG. 2.

After passing the yellow development station the image area and its two toner layers advance past the precharge exposure lamp 18, which is once again illuminated so as to discharge the image area. This is the start of the third cycle. The AC scorotron 22 then recharges the image area and its two toner layers in preparation for the third exposure station. The exposure station 24 again exposes the image area to the laser beam 26, this time with a light representation that discharges some parts of the image area to create an electrostatic latent representation of a magenta image. The image area then advances through a magenta development station 32 that deposits a third toner layer on the image area. Like the black and the yellow development stations, the magenta development station is a hybrid scavengeless developer powered by a 1500 V peak-to-peak AC squarewave superimposed on −500 volts DC. Furthermore, the magenta development station is selectively powered using the high voltage power supply system 100 shown in FIG. 2.

The image area with it three toner layers then advances past the illuminated precharge erase lamp 18 and the fourth cycle begins. The AC scorotron 22 again recharges the image area (which now has three toner layers) to produce the desired charge on the photoreceptor. The substantially uniformly charged image area with its three toner layers then advance once again to the exposure station 24. The exposure station exposes the image area again, this time with a light representation that discharges some parts of the image area to create an electrostatic latent representation of a cyan image. After passing the exposure station the image area passes the cyan development station 34. Like the black, yellow, and magenta development stations, the cyan development station is a hybrid scavengeless developer powered by a 1500 V peak-to-peak AC squarewave superimposed on −500 volts DC. Furthermore, the cyan development station is selectively powered using the high voltage power supply system 100 shown in FIG. 2.

After passing the cyan development station the image area has four toner layers which together make up a composite color toner image. That composite color toner image is comprised of individual toner particles that have charge potentials that vary widely. Indeed, some of those particles take a positive charge. Transferring such a composite toner image onto a substrate would result in a degraded final image. Therefore it is beneficial to prepare the composite color toner image for transfer.

To prepare for transfer a pretransfer erase lamp 39 discharges the image area to produce a relatively low charge level on the photoreceptor. The image area then passes a DC corotron 40 that performs a pre-transfer charging function by supplying sufficient negative ions to the image area such that substantially all of the previously positively charged toner particles are reversed in polarity.

The image area continues to advance in the direction 12 past the driven roller 14. A substrate 46 is then placed over the image area using a sheet feeder (which is not shown). As the image area and substrate continue their travel they pass a transfer corotron 48. That corotron applies positives ions onto back of the substrate 46. Those ions attract the negatively charged toner particles onto the substrate.

As the substrate continues its travel it passed a detack corotron 50. That corotron neutralizes some of the charge on the substrate to assist separation of the substrate from the photoreceptor 10. As the lip of the substrate moves around the tension roller 16 the lip separates from the photoreceptor. The substrate is then directed into a fuser 52 where a heated fuser roller 54 and a pressure roller 56 create a nip through which the substrate 46 passes. The combination of pressure and heat at the nip causes the composite color toner image to fuse into the substrate. After fusing, a chute, not shown, guides the substrate to a catch tray, also not shown, for removal by an operator.

After the substrate is separated from the photoreceptor belt 10 the image area continues its travel and passes a preclean erase lamp 58. That lamp neutralizes most of the residual toner and/or debris on the photoreceptor is removed at a cleaning station 60. At the cleaning station cleaning brushes wipe residual toner particles from the image area. This marks the end of the print cycles. The image area then passes once again to the precharge erase lamp and the start of another 4 cycles.

The principles of the present invention directly relate to selectively applying power to the developers 28, 30, 32 and 34. FIG. 2 presents a block diagram of the high voltage power supply system 100. That power supply system includes a high voltage power supply 102 that produces −500 volt DC. That voltage is applied to a high voltage multiplexer 104. Also input to the high voltage multiplexer 104 is a clock signal from a clock oscillator 106 and control signals from a system controller 108. The system controller 108, which typically includes a microprocessor that operates under control of a software program, controls the overall operation of the printer 8. In particular, the system controller 108 signals which of the developers is to be powered at a given time.

In operation, the high voltage multiplexer 104 receives the −500 volt DC from the high voltage power supply 102. The high voltage multiplexer the chops the −500 volt DC into a 1500 volt peak-to-peak squarewave at a rate controlled by a clock signal from the clock oscillator 106. When the system controller 108 signals that a particular developer is to be powered the high voltage multiplexer drives one of the lines 110, 112, 114, or 116 to power, respectively, either the black development station 28, the yellow development station 30, the magenta development station 32, or the cyan development station 34.

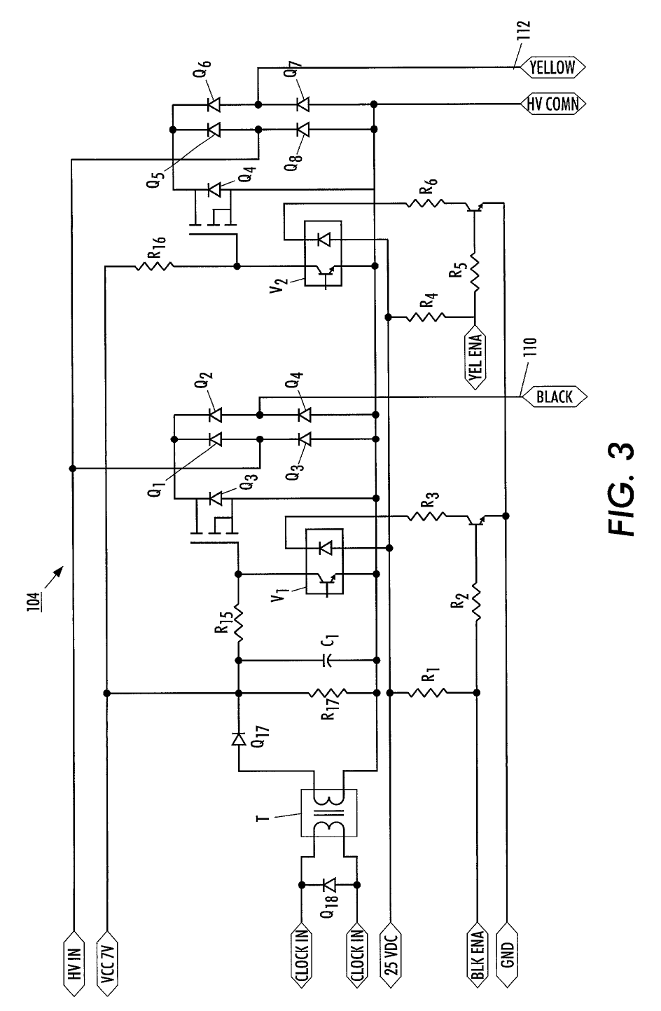

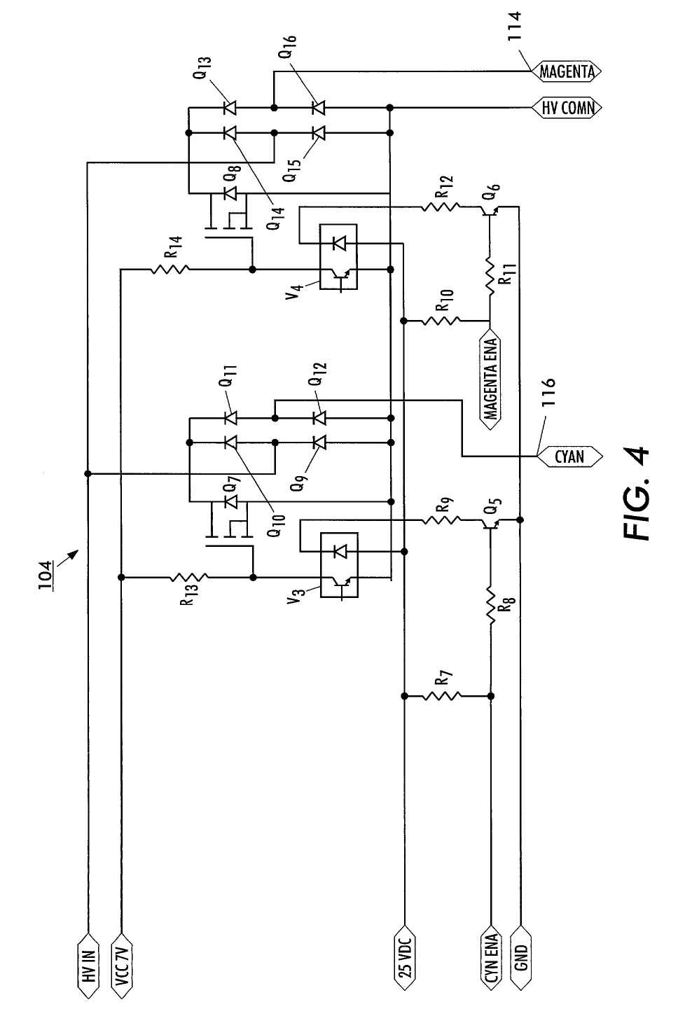

A specific implementation of the high voltage multiplexer 104 is illustrated in FIGS. 3 and 4. Referring now FIGS. 3 and 4, the high voltage (IIV IN) is applied to the high voltage multiplexer 104 from the high voltage power supply 102. Furthermore, a common ground (GND), a 7V DC supply (supplied by a high input impedance), and a 25V DC supply are also input to the high voltage multiplexer from the high voltage power supply 102. The clock oscillator 106 applies a clock signal (see FIG. 3), while the system controller supplies a black enable (BLK ENA) and a yellow enable (YEL ENA) to FIG. 3 and a magenta enable (MGM EN) and a cyan enable (CYN ENA) to FIG. 4.

That power supply system includes a high voltage power supply 102 that produces −500 volt DC. That voltage is applied to a high voltage multiplexer 104. Also input to the high voltage multiplexer 104 is a clock signal from a clock oscillator 106 and control signals from a system controller 108. The system controller 108, which typically includes a microprocessor that operates under control of a software program, controls the overall operation of the printer 8.

It is to be understood that while the figures and the above description illustrate the present invention, they are exemplary only. Others who are skilled in the applicable arts will recognize numerous modifications and adaptations of the illustrated embodiments that will remain within the principles of the present invention. Therefore, the present invention is to be limited only by the appended claims.

What is claimed:

1. A high voltage multiplexer for converting a high voltage DC signal into an AC modulated DC signal that is selectively applied to one of a plurality of outputs, with the selected output depending on signals applied to a set of control inputs.

2. A power supply system, comprising:
a high voltage DC source producing a DC input voltage;
a clock oscillator for producing a clock input;
a set of control inputs for receiving control signals;
a plurality of output lines; and
a multiplexer for converting said DC input voltage into an AC modulated DC power signal that is selectively applied to one of said plurality of outputs lines, with the AC modulation frequency being controlled by the clock input, and with the selected output line controlled by signals applied to the set of control inputs.

3. An electrophotographic printer, comprising:
according to the principles of the present invention includes a plurality of developers, a controller, and a power supply system that selectively powers the developers as directed by signals from the controller. The power supply system includes a high voltage DC power supply, a clock oscillator, a set of control inputs for receiving control signals from the controller, and a plurality of output lines connected to the developers. The high voltage DC input is converted into an AC modulated DC power signal that is selectively applied to one of the developers, with the AC frequency being controlled by the clock input, and with the selected developers controlled by signals applied to the se t of control inputs.
